(19) United States
(12) Patent Application Publication
(10) Pub. No.: US 2016/0021101 A1
(43) Pub. Date: Jan. 21, 2016

(54) METHOD FOR BACKING UP A USER SECRET AND METHOD FOR RECOVERING A USER SECRET

(71) Applicant: ERCOM ENGINEERING RESEAUX COMMUNICATIONS, VELIZY VILLACOUBLAY (FR)

(72) Inventors: MARTIN BALC'H, PARIS (FR); JULIEN KOWALSKI, EGRISELLES VENOY (FR); ERIC LAUBACHER, BOIS D'ARCY (FR); RENAUD LEHOUX, SAINT-CYR L'ECOLE (FR)

(21) Appl. No.: 14/803,092

(22) Filed: Jul. 19, 2015

(30) Foreign Application Priority Data
Jul. 21, 2014 (FR) 14 57016

(51) Int. Cl. H04L 29/06

(52) U.S. Cl. CPC H04L 63/0823; H04L 63/061; H04L 63/083; H04L 63/0435

(57) ABSTRACT

A method for backing a user secret and recovering a user secret. A set of mandatory trustees possessing a public key and a set of non-mandatory trustees possessing a public key are determined. A predetermined limit value of a number of partitions necessary for recovering the secret is selected by the user. A number of primary partitions equal to the number of mandatory trustees is generated in response to the determination that the set of non-mandatory trustees is empty. A number of primary partitions equal to the number of mandatory trustees plus one is generated in response to the determination that the set of non-mandatory trustees is not empty. Each partition is encrypted using the public key of the corresponding trustee and each encrypted partition is stored in a server.

### FIELD OF THE INVENTION

The present invention relates to a method for backing up a user secret, a method for recovering a user secret, a device for backing up a user secret, and a device for recovering a user secret. The invention particularly applies to the field of cryptography. The present invention applies to the backup and recovery of secrets, more particularly in the field of “cloud” storage means in which the secret to be backed up is a key repository (“keystore”).

### PRIOR ART

Currently, there are several ways of backing up secrets, such as passwords for example. First of all, there are password-protected means for backing up secrets such as the Keeper (registered trademark) application, or the iTunes (registered trademark) application that makes it possible to back up and recover data contained in a device sold by Apple, Inc. by means of a password. This technique requires the user to remember a different password that depends on the nature of the secret. Moreover, the security of the secret provided by a password depends on the complexity of the password, which is inversely proportional to the ease with which the user is able to memorize the password or the ease with which the user is able to type in the password. The user must compromise between the security and the ergonomics of the system.

The article “Using a high-performance, programmable secure coprocessor” by Sean W. Smith and al., published in February 1998 for the “2nd International Conference on Financial Cryptography,” provides a second example of the backing up of secrets: the backup of secrets protected by an encryption key managed by a trusted hardware device. The use of trusted hardware solves the compromise problem posed by password-protected secret backup. However, the user must have the trusted hardware on hand in all circumstances.

Another technique for backing up secrets is backup protected by an encryption key managed by a trusted third party, such as for example the Amazon S3 (registered trademark) “server side encryption” service. “Server side encryption” makes it possible to encrypt data backed up in an Amazon S3 “cloud” storage space, the encryption being managed by Amazon.

Similarly, there are also key escrow methods, which enable an escrow authority to access said keys even when the user has forgotten the secrets that make it possible to access said keys. Key escrow methods are explained in the report “Requirements for key recovery products” by the NIST (“National Institute of Standards and Technologies”), published in November 1998. Encrypted backup solutions in which the encryption key is managed by a third party solve the problems raised by the first two techniques. In essence, this technique does not require a password, nor does it necessitate the use of a trusted hardware device, but the user has to place trust in a third party that manages the encryption and that has access to the data backed up by the user.

Finally, there are various secret sharing methods, which consist of dividing, among several third parties, the secret elements to be backed up. Secret sharing methods are described in the articles “Safeguarding cryptographic keys” by Blakley, G. R., published in June 1979 in “Proceedings of the 1979 AFIPS National Computer Conference, Volume 48,” and “How to share a secret” by Shamir, Adi, published in November 1979 in “Magazine Communications of the ACM, Volume 22 Issue 11.” Secret sharing methods propose mathematical sharing methods that are not designed to be ergonomic.

U.S. Pat. No. 7,916,871 describes a method for backing up the keys for sensitive hardware using secret sharing. The method described in U.S. Pat. No. 7,916,871 is such that trustees of parts of a secret perform the backup and recovery actions in concerted fashion. A user wishing to initiate the backup or recovery of the secret cannot use the method described. Moreover, the method described in U.S. Pat. No. 7,916,871 has weak resistance to long-term attacks.

### Object of the Invention

The present invention seeks to completely or partially eliminate these drawbacks.

To this end, according to a first aspect, the present invention relates to a method for backing up a user secret which comprises the following steps:
determination of a set of trustees called “mandatory trustees,” each trustee possessing a public key, this set possibly being empty,
determination of a set of trustees called “non-mandatory trustees,” each trustee possessing a public key, this set possibly being empty,
selection by the user of a predetermined limit value of a number of partitions necessary for recovering the secret, said predetermined limit value being greater than or equal to the number of mandatory trustees,

if the determined set of non-mandatory trustees is empty
creation of a number of partitions called “primary partitions” equal to the number of mandatory trustees, each partition comprising at least a part of the secret and corresponding to a mandatory trustee;

if the determined set of non-mandatory trustees is not empty
creation of a number of partitions called “primary partitions,” equal to the number of mandatory trustees plus one, each partition comprising at least a part of the secret and each partition except one corresponding to a mandatory trustee and
generation of a number of partitions called “secondary partitions” comprising the content of the remaining primary partition divided in accordance with a secret sharing method and corresponding to a non-mandatory trustee;
encryption of each primary partition and each secondary partition by means of the public key of the corresponding trustee and
storing of each encrypted partition in a server.

It will be recalled that a public key is one of the keys of a key pair (also referred to in French as a “biclef”) in a public key infrastructure (or “PKI”).

These embodiments have the advantage of increasing the security of the backed-up secret since the confidentiality and integrity of the backed-up secret are independent of the quality of a password. Moreover, the security of the backed-up secret does not depend on the user's trusting a single third party. Furthermore, the user does not need to memorize an element such as a password or have any trusted hardware. These embodiments also make it possible to obtain enhanced ergonomics and integrity. In fact, the backup of the secret is fully automated once the user has selected each trustee of the secret.

In some embodiments, at least one trustee is a server.

Having a server as a trustee makes it possible to have a partition of the backup corresponding to a server. During a recovery of the secret, the recovery procedure is simplified for the user, and the duration of the procedure is shortened. Moreover, the server is available at any time.

In some embodiments, at least one trustee is a user.

These embodiments offer the advantage of being able to authenticate a trustee vocally or visually for example, and of being able to detect the source of a disclosure of a partition of the secret. In essence, certain compromised server problems are avoided and the user can evaluate the level of trust to be placed in a trustee user. Moreover, in the embodiments in which the user selects at least one trustee server and at least one trustee user, the backup and potential recovery of the secret are not exclusively computer-based. The user of the device can therefore be assured of confidentiality in case of an attack on the server.

According to a second aspect, the present invention relates to a method for recovering a user secret which comprises the following steps:
establishment of a secure channel between the user and at least one predetermined limit value of trustees of a partition of the secret, said predetermined limit value corresponding to a number of partitions of the secret necessary for recovering the secret, the user authenticating each trustee and each trustee authenticating the user,
request for recovery of the secret by the user to a server,
decryption of at least the predetermined limit value of partitions, each partition being decrypted by means of a private key of said corresponding trustee,
transmission to the user by each trustee corresponding to said decrypted trustee, by means of the established secure channel and
reconstruction by the user of the secret from each decrypted partition.

The advantage of these embodiments is to distribute the secret so as to make recovery possible from a part of the partitions of the secret. Moreover, each trustee is independent of the others, and the partition of the secret corresponding to that trustee does not reveal the number of trustees and the content of the other partitions. Furthermore, the established secure channel ensures the confidentiality and integrity of the data passing through the channel, and the establishment of the secure channel is independent of any memorization of a secret by a user.

In some embodiments, the method for recovering a secret according to the present invention also comprises the following steps:
sending of an authentication challenge to the user by the server,
transmission by the user to the server of the response to the authentication challenge, authenticating the user in the server.

The advantage of this embodiment is that it enables the server to authenticate the user requesting the recovery of the secret or to authenticate a trustee user accepting the recovery of a partition of the secret.

In some embodiments, the method for recovering a secret according to the present invention also comprises a step for establishing a secure channel between the user and a trustee user which comprises the following steps:
determination of a password by the user,
sending by the user of a Diffie-Hellman exchange called a “user Diffie-Hellman exchange” encrypted by said password to a trustee user by means of the server,
determination of a password called a “trustee password” by the trustee user,
sending by said trustee user of a Diffie-Hellman exchange called a “trustee Diffie-Hellman exchange” encrypted by said trustee password to the user by means of the server,
reciprocal authentication of the user and of said trustee user via a third-party channel,
exchange of each password between the user and said trustee user by means of said third-party channel,
decryption of the trustee Diffie-Hellman exchange by means of the trustee password by the user and
decryption of the user Diffie-Hellman exchange by means of the password by said trustee user.

It will be recalled that a Diffie-Hellman exchange, in cryptography, consists in a key exchange in a method whereby two persons can agree on a number (which they can use as a key to encrypt the next conversation) without a third person's being able to discover the number, even by having listened to all of their exchanges. The user Diffie-Hellman exchange is the part of the exchange performed by the user and the trustee Diffie-Hellman exchange is the part of the exchange performed by the trustee.

These embodiments have the advantage of having an interaction, preferably by telephone, between the user and a trustee user for the purpose of verifying the identity of the user. In some embodiments, the trustee and the user identify themselves to the server and the trustee and the user identify themselves to each other, and the security of the backup is thus enhanced. Moreover, the use of Diffie-Hellman exchanges increases robustness.

In some embodiments, the step for requesting the recovery of the secret comprises a step for notifying the trustee of a recovery request.

The advantage of these embodiments is that the trustee is informed that an action by said trustee in an operation for recovering a secret is being requested.

In some embodiments, at least one partition corresponds to a server and at least one partition corresponds to a user, and the step for decrypting each partition corresponding to each server is performed after the authentication of the user by each trustee user.

These embodiments have the advantage of increased security, since the server does not decrypt and disclose its partition until after a multifactor authentication that includes both a response to the challenge and an authentication of the user by each trustee user.

In some embodiments, each step for the transmission by each trustee of the partition corresponding to said decrypted trustee is performed after each secure channel between the user and each trustee is established.

The advantage of these embodiments is waiting until all of the steps for establishing secure connections are complete before transferring the partitions to be decrypted.

According to a third aspect, the present invention relates to a device for backing up a secret which comprises:
a program memory and
a central processing unit which comprises at least one server and which, by executing instructions of the program, performs the steps of the backup method according to the present invention.

These embodiments have the advantage of having a program stored in a memory for implementing the method for backing up a secret.

According to a fourth aspect, the present invention relates to a device for recovering a secret, which comprises:
a program memory and
a central processing unit which comprises at least one server and which, by executing instructions of the program, performs the steps of the recovery method according to the present invention.

The advantage of these embodiments is that they implement a method for recovering a secret by means of a program stored in a memory.

### BRIEF DESCRIPTION OF THE FIGURES

Other advantages, objects and features of the invention will emerge from the following nonlimiting description of at least one particular embodiment of a method for backing up a user secret, a method for recovering a user secret, a device for backing up a user secret, and a device for recovering a user secret, in which:

FIG. 1 represents, in the form of a flowchart, the steps of a particular embodiment of a backup method according to the present invention,

FIG. 2 represents, in the form of a flowchart, the steps of a particular embodiment of a recovery method according to the present invention,

FIG. 3 represents, in the form of a flowchart, the steps of a second particular embodiment of a recovery method according to the present invention,

FIG. 4 represents, in the form of a flowchart, the steps of a third particular embodiment of a recovery method according to the present invention,

FIG. 5 represents, in the form of a flowchart, the steps of a fourth particular embodiment of a method according to the present invention and,

FIG. 6 schematically represents a device for backing up a secret and/or for recovering a secret according to the present invention.

### DESCRIPTION OF EXEMPLARY EMBODIMENTS OF THE INVENTION

It should be noted at the outset that the figures are not to scale.

A secret is hereinafter defined as being an element for authenticating the user with various services, such as for example a private signature key or password, and/or an encrypted document.

A “trustee” is defined as being a user, a server, or a storage means that can be authenticated by the user to which a partition of the secret corresponds. The trustee corresponds to a partition of the secret but the trustee does not have access to the content of this partition of the secret. In the case of the use of a single server that is the trustee of a partition of the secret and that handles the steps of a method for backing up a secret according to the present invention and/or the steps of a method for recovering a secret according to the present invention, said server has access to the content of the partition corresponding to said server.

An application is defined as being a computer program installed in a computer, a communicating portable terminal such as a mobile telephone, preferably of the Smartphone type, a tablet computer, or a portable computer, for example.

In the embodiments described below, each connection of a user to a server is protected in terms of confidentiality and integrity, and said server is authenticated by said user. The connection of a user to a server takes place by means of a TLS (the acronym for “Transport Layer Security”) connection, for example.

A server is defined as being a computer hardware or software device. A server can handle the steps of a method for backing up a secret according to the present invention. A server can handle the steps of a method for recovering a secret according to the present invention. Preferably, the same server handles the steps of both the method for backing up a secret and the method for recovering a secret. A server can also be a trustee of the secret. The server handling the steps of the method for backing up a secret and/or the method for recovering a secret can be a trustee of a partition of the secret.

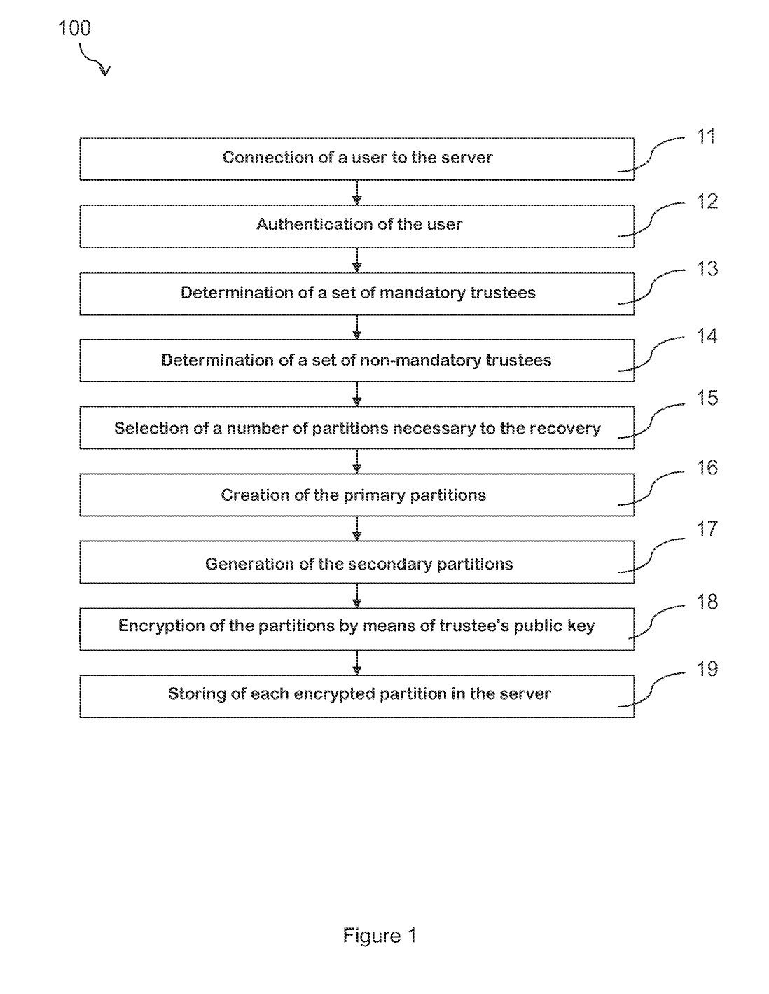

We see in FIG. 1 the steps of a particular embodiment 100 of the backup method according to the present invention.

The method 100 comprises the following steps:
connection 11 of a user to a server,
authentication 12 of the user,
determination 13 of a set of trustees called “mandatory trustees,” each trustee possessing a public key, this set possibly being empty,
determination 14 of a set of trustees called “non-mandatory trustees,” each trustee possessing a public key, this set possibly being empty,
selection 15 by the user of a predetermined limit value of a number of partitions necessary for recovering the secret, said predetermined limit value being greater than or equal to the number of mandatory trustees,

if the set of determined non-mandatory trustees is empty
creation 16 of a number of partitions called “primary partitions” equal to the number of mandatory trustees, each partition comprising at least a part of the secret and corresponding to a mandatory trustee;

if the set of determined non-mandatory trustees is not empty
creation 16 of a number of partitions called “primary partitions” equal to the number of mandatory trustees plus one, each partition comprising at least a part of the secret and each partition except one corresponding to a mandatory trustee et
generation 17 of a number of partitions called “secondary partitions” comprising the content of the remaining primary partition divided in accordance with a secret sharing method and corresponding to a non-mandatory trustee;
encryption 18 of each primary partition and each secondary partition by means of the public key of the corresponding trustee and
storing 19 of each encrypted partition in the server.

Step 11 for connecting a user to the server is performed by means of an application. The connection to the server is preferably a TLS connection.

The connection step 11 is followed by a step 12 for authenticating the user. The authentication step 12 can be an authentication by:
password,
PIN (acronym for “Personal Identification Number”) code,
secret phrase,
magnetic card,
RFID (acronym for “Radio Frequency Identification”),
USB (acronym for “Universal Serial Bus”) key,
smart card,
communicating portable terminal, for example of the smartphone type,
fingerprint,
retinal scan,
a biometric element,
voice recognition,
or any other form of authentication.

The authentication step 12 can be an authentication of the strong authentication type. It is noted that in information systems security, a strong authentication is an authentication procedure that requires the concatenation of at least two authentication factors.

After the user is authenticated, the user advances to step 13 for determining a set of mandatory trustees, the set possibly being empty. A mandatory trustee is a trustee whose partition is necessary to the recovery process.

Preferably, at least one user, called a “contact,” who can be a trustee user, is stored in the user application. At least one server called a “contact server,” which can be a trustee server, is presented to the user by means of the user application. The determination of the set of mandatory trustees is a selection by the user of at least one stored contact and/or one presented contact server. During the selection by the user, the user can designate each selected trustee as being a mandatory trustee or a non-mandatory trustee.

Once each mandatory trustee is designated, the user performs step 14 for determining a set of non-mandatory trustees, the set possibly being empty. A non-mandatory trustee is a trustee corresponding to a secondary partition.

Preferably, the determination of the set of non-mandatory trustees is a selection by the user of at least one stored contact and/or one presented contact server designated as a non-mandatory trustee. The set of non-mandatory trustees is empty if the user has not selected any contacts or contact servers as a non-mandatory trustee of a partition of the secret.

Each trustee possesses a public key. A trustee can be another user called a “trustee user” or a server. The user determines a number n of non-mandatory trustees and a number p of mandatory trustees.

Step 15 for the selection by the user of a predetermined limit value of a number of partitions necessary for recovering the secret, said predetermined limit value being greater than or equal to the number p of mandatory trustees, is then performed by means of the user application. The predetermined limit value may be equal to the number p of mandatory trustees plus at least one non-mandatory trustee, for example. The predetermined limit value is stored in the server. The partitions necessary for recovering the secret are at least each partition corresponding to each mandatory trustee.

Preferably, the user application offers the user a number of non-mandatory trustees n such that the predetermined limit value selected by the user is equal to n+p, n being a positive integer. Each non-mandatory trustee is designated as such by the user in step 14 for determining a set of non-mandatory trustees.

During step 15 for selecting the predetermined limit value, the application stores in the server the identifier of each trustee and the predetermined limit value selected by the user. During step 15, the user application stores each trustee corresponding to a partition necessary to the recovery of the secret.

A partition of the secret is preferably such that, for a number n of non-mandatory trustees and a number p of mandatory trustees, p being a positive integer, n being a positive integer, a secret K is divided into:
a number p+1 of partitions K_{q} called “primary partitions,” preferably random, q being a number between one and p+1, such that K=K₁ XOR . . . XOR Kₚ₊₁ and
the primary partition Kₚ₊₁ is divided into n distinct values called “secondary partitions,” in accordance with a secret sharing method.

If the determined set of non-mandatory trustees is empty, the method advances to step 16 for creating a number p of partitions called “primary partitions” equal to the number of mandatory trustees, each partition comprising at least a part of the secret and corresponding to a mandatory trustee. The generation step 17 is not performed.

If the set of non-mandatory trustees is not empty, the backup method advances to step 16 for creating a number of primary partitions equal to the number of mandatory trustees p plus one, comprising at least a part of the secret, the p primary partitions each corresponding to a distinct mandatory trustee, the remaining partition being divided among secondary partitions in accordance with a secret sharing method.

The step for creating the number of partitions is such that a number p+1 of random primary partitions K_{q} are created, q being a number between one and p+1, such that K=K₁ XOR . . . XOR Kₚ₊₁. Each partition K_{q} for q between 1 and p is assigned to a mandatory trustee. A secret sharing method is selected based on the type of secret to be backed up.

The generation step 17 consists in generating a number n of secondary partitions comprising the content of the remaining partition Kₚ₊₁ of the secret. Each secondary partition is divided in accordance with a secret sharing method and each secondary partition corresponds to a non-mandatory trustee. Each secondary partition corresponding to a non-mandatory trustee is such that the partition Kₚ₊₁ is divided into n distinct values in accordance with a secret sharing method. The secret sharing method is a method described in the article “How to share a secret” by Shamir, Adi, published in November 1979 in “Magazine Communications of the ACM, Volume 22 Issue 11.”

Once the n+p partitions are created, each partition is encrypted during step 18 for encrypting each partition by means of the public key of the corresponding trustee.

Step 19 for storing each encrypted partition in the server is then performed. During the storage step 19, the server stores the correspondences between each partition and each trustee and logs this step.

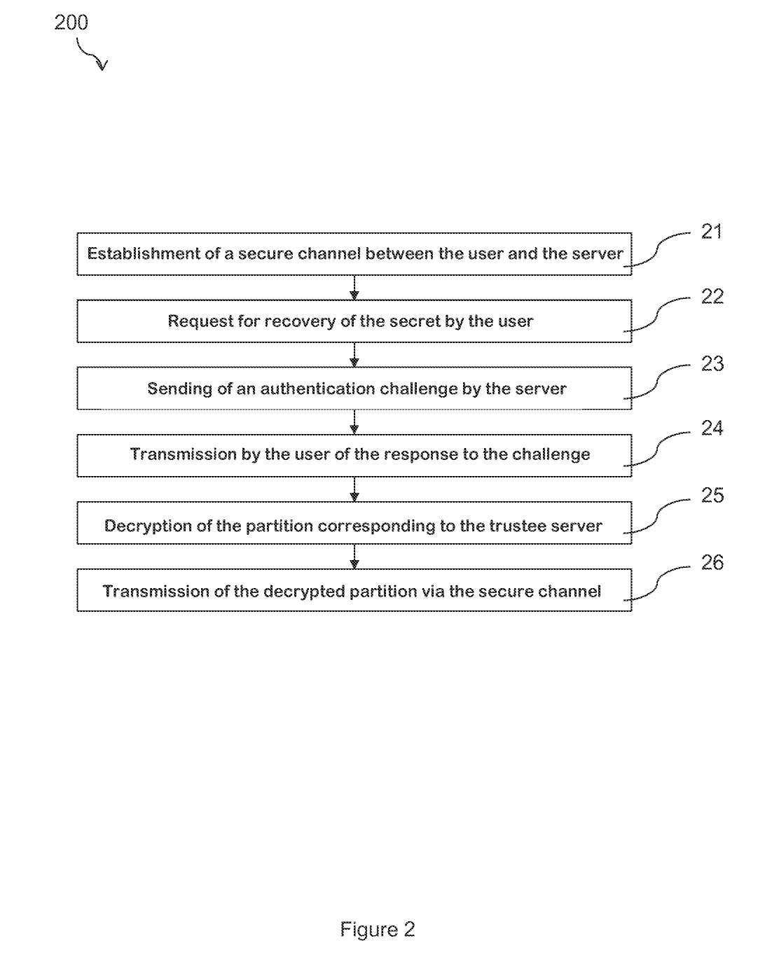

We see in FIG. 2 the steps of a particular embodiment of a recovery method 200 according to the present invention. The method 200 is an embodiment wherein a trustee is a server. The method 200 describes in detail the steps for obtaining the transmission to the user of the decrypted partition corresponding to a trustee server.

The method 200 comprises the following steps:
establishment 21 of a secure channel between the user and a trustee server, the user authenticating the trustee server,
request 22 for recovery of the secret by the user to the server,
sending 23 of an authentication challenge to the user by the server,
transmission 24 by the user to the server of the response to the challenge by the server authenticating the user,
decryption 25 of the partition corresponding to the trustee server, the partition being decrypted by means of a private key of said authenticated trustee server and
transmission 26 of the decrypted partition by the server to the user by means of the established secure channel.

The establishment 21 of a secure channel between the user and a trustee server, the user authenticating the trustee server, is performed by means of the user application. The establishment 21 of the secure channel is preferably a TLS connection.

The user advances to step 22 for requesting the recovery of the secret. Preferably, the request to recover the secret comprises means for identifying the secret to be recovered. The request is logged by the server that accepts the request.

The request is preferably a query performed by means of a user application. The user application includes a graphical interface element called “Recover my secrets” or “I lost my secrets,” for example, which initiates the query. The graphical interface element is placed on the user identification page in the user application, for example.

The method for recovering the partition entrusted to the server comprises a step 23 for sending an authentication challenge to the user from the server. The challenge is preferably a URI (acronym for “Uniform Resource Identifier”) sent by email to the user. The challenge can be sent by SMS (acronym for “Short Message Service”) or MMS (acronym for “Multimedia Messaging Service”). The challenge can be provided by the user application.

Step 23 is followed by a step 24 for transmitting a response to the authentication challenge to the server. The transmission 24 of the response is preferably performed using the TLS protocol.

The sending 23 and transmission 24 steps implicitly authenticate the user to the server as being the legitimate user of the means receiving the sending of the challenge, the receiving means being an application for example. After the authentication of the user in the server, the server accepts the recovery request.

Once the authentication is validated, the server advances to the decryption 25 of the partition for which the trustee server is the trustee by means of the private key of said trustee server. Step 26 for the transmission of the partition decrypted by the server to the user by means of the secure channel is performed after the decryption of the partition by the trustee server. The transmission is preferably performed using a TLS protocol. Steps 25 and 26 are included in a step 27 for the recovery by the user of a decrypted partition.

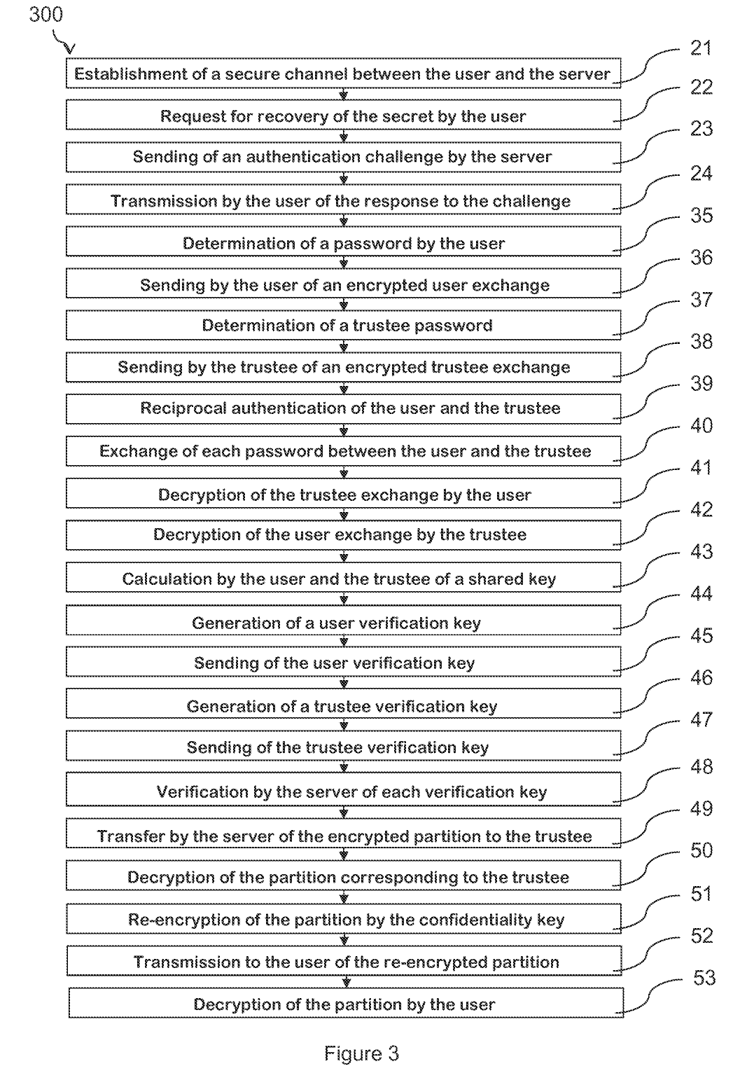

We see in FIG. 3 the steps of a particular embodiment of a method for recovering a secret according to the present invention.

The method 300 is an embodiment wherein a trustee is a user called a “trustee user.” The method 300 describes in detail the steps for obtaining the transmission to the user of the decrypted partition of the secret corresponding to a trustee user.

The method 300 comprises the following steps:
establishment 21 of a secure channel between the user and a server, the user authenticating the server,
request 22 for recovery of the secret by the user to the server,
sending 23 of an authentication challenge to the user by the server,
transmission 24 by the user to the server of the response to the challenge by the server authenticating the user,
determination 35 of a password by the user,
sending 36 by the user of a Diffie-Hellman exchange called a “user Diffie-Hellman exchange” encrypted by said password to a trustee user by means of the server,
determination 37 of a password called a “trustee password” by the trustee user,
sending 38 by said trustee of a Diffie-Hellman exchange called a “trustee Diffie-Hellman exchange” encrypted by said trustee password to the user by means of the server,
reciprocal authentication 39 of the user and said trustee user via a third party channel, which cannot be modified on the fly,
exchange 40 of each password between the user and said trustee user by means of said third party channel,
decryption 41 of the trustee Diffie-Hellman exchange by means of the trustee password by the user,
decryption 42 of the user Diffie-Hellman exchange by means of the password by said trustee user,
calculation 43 by the user and said trustee user of a shared key by means of each Diffie-Hellman exchange,
generation 44 of a verification key called a “user verification key” derived from the shared key calculated by the user, and of a confidentiality key called a “user confidentiality key” derived from the shared key calculated by the user,
sending 45 to the server of said user verification key,
generation 46 of a verification key called a “trustee verification key” derived from the shared key calculated by said trustee user, and of a confidentiality key called a “trustee confidentiality key” derived from the shared key calculated by the trustee user
sending 47 to the server of said trustee verification key,
verification 48 by the server of each verification key,
transfer 49 by the server of the encrypted trustee partition to the trustee user,
decryption 50 of the partition corresponding to said trustee user, the partition being decrypted by means of a private key of said corresponding authenticated trustee user,
re-encryption 51 of the partition corresponding to said trustee user by said trustee user by means of the trustee confidentiality key,
transmission 52 by the trustee of the partition to the user, encrypted by the trustee confidentiality key,
decryption 53 by the user of the partition transmitted by the trustee user by means of the user confidentiality key.

The establishment 21 of a secure channel between the user and a server, the user authenticating the server, is performed by means of an application. The establishment 21 of the secure channel is preferably a TLS connection.

The user advances to step 22 for requesting the recovery of the secret. The request is logged by the server that accepts the request. The request is preferably sent by means of a user application.

The method for recovering the partition entrusted to the server comprises a step 23 for sending an authentication challenge to the user from the server. The challenge is preferably a URI sent to the user by email. The challenge can be sent by SMS or MMS. The challenge can be provided by the user application.

Step 23 is followed by a step 24 for the transmission by the user to the server of a response to the authentication challenge. The transmission 24 of the response is preferably performed by means of the TLS protocol.

The sending 23 and transmission 24 steps implicitly authenticate the user to the server as being the owner of the means for receiving the sending of the challenge. Following the authentication of the user in the server, the server accepts the recovery request If the response to the authentication challenge sent by the user to the server is incorrect, the server terminates the secret recovery method.

Once the user is authenticated by the server and the server is authenticated by the user, the method advances to a step 35 for the determination of a password by the user. The password is determined by means of a user application. The password is preferably a short code of the PIN type. Preferably, the password comprises four digits.

Step 36 for the sending by the user of a Diffie-Hellman exchange called a “user Diffie-Hellman exchange” encrypted by said password to the trustee user by means of the server is performed immediately after the determination 35 of the password.

The method advances to a step 37 for determining a trustee password. The trustee password is determined by means of an application of the trustee user. The trustee password is preferably a short code of the PIN type. The trustee password is preferably in the same format as the password determined in step 35.

Step 38 for the sending by said trustee user of a Diffie-Hellman exchange called a “trustee Diffie-Hellman exchange” encrypted by said trustee password to the user by means of the server is performed immediately after the determination 37 of the password.

Steps 35 and 37 for determining each password can be performed in parallel. Steps 36 and 38 for sending each Diffie-Hellman exchange can be performed in parallel.

Once the encrypted Diffie-Hellman challenges have been transmitted by means of the server, the user and the trustee user enter into communication, preferably by telephone, and perform step 39 for the reciprocal authentication of the user and said trustee user via a third party channel. Preferably, the third party channel cannot be modified on the fly. The authentication is preferably oral.

Once the authentication 39 is complete, the user and the trustee user proceed to step 40 for exchanging each password by means of said third party channel. The trustee user transmits the trustee password to the user and the user transmits the password to the trustee by means of said third party channel. The third party channel is a communication means such as a secure telephone call, for example.

The decryption 41 of the trustee Diffie-Hellman exchange is performed by the user by means of the trustee password. Similarly, the trustee user performs the decryption 42 of the user Diffie-Hellman exchange by means of the password.

Steps 41 and 42 can be performed in parallel.

Steps 35 through 42 constitute a step for establishing a secure channel between the user and the trustee user. The step for establishing a secure channel between the user and the trustee user preferably takes place without any prior secret sharing.

In some embodiments, steps 35 through 42 can be replaced by the establishment of a secure channel by means of the ZRTP protocol; the ZRTP protocol ZRTP being configured to generate a shared key.

The calculation 43 by the user and said trustee user of a shared key is performed by means of each decrypted Diffie-Hellman exchange.

The user application generates 44 a verification key called a “user verification key” derived from the shared key calculated by the user, and a confidentiality key called a “user confidentiality key” derived from the shared key calculated by the user. The user verification key and the user confidentiality key are obtained in similar fashion. The user application sends 45 said user verification key to the server.

The trustee application generates 46 a verification key called a “trustee verification key” derived from the shared key calculated by said trustee user, and a confidentiality key called a “trustee confidentiality key” derived from the shared key calculated by the trustee user. The trustee verification key and the trustee confidentiality key are obtained in similar fashion. The user application sends 47 said user verification key to the server.

The server proceeds with the verification 48 of each verification key. If the verification keys are incorrect, the server terminates the secret recovery procedure.

Once each verification key is verified by the server, the server transfers 49 the encrypted trustee partition to the trustee.

The trustee user then decrypts 50 the partition corresponding to said trustee user, the partition being decrypted by means of the private key of said authenticated trustee user corresponding to the partition. The trustee user then re-encrypts 51 the partition corresponding to said trustee user by means of the trustee confidentiality key calculated in step 46.

The trustee user transmits 52 the partition to the user, said partition being encrypted by the trustee confidentiality key by means of the server.

The user then decrypts 53 the partition transmitted by the trustee user by means of the user confidentiality key generated in step 46.

Steps 35 through 52 are included in a step 54 for the recovery by the user of a decrypted partition.

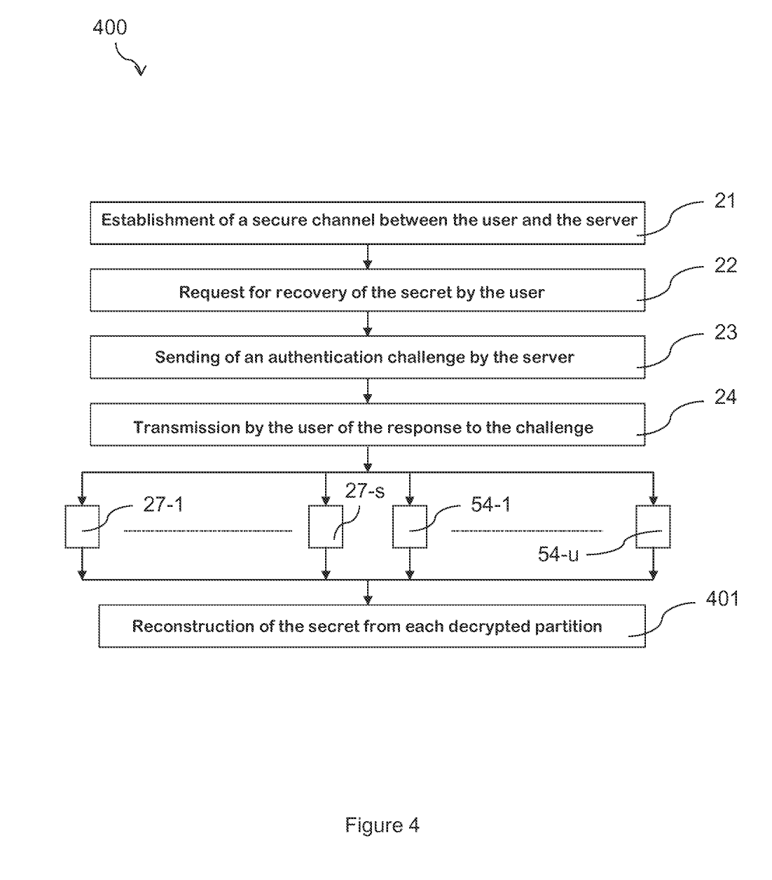

We see in FIG. 4 the steps of a third embodiment 400 of a recovery method according to the present invention.

The method 400 is an embodiment wherein s trustees are servers, s being a positive integer, and u trustees are trustee users, u being a positive integer. The method 400 describes in detail the steps for reconstructing the secret from at least each decrypted partition corresponding to each trustee, necessary to the recovery of the secret.

The method 400 comprises the following steps:
establishment 21 of a secure channel between the user and a server, the user authenticating the server,
request 22 for recovery of the secret by the user to the server,
sending 23 of an authentication challenge to the user by the server,
transmission 24 by the user to the server of the response to the challenge authenticating the user in the server.
recovery 27-1 through 27-s and 54-1 through 54-u, of each s+u decrypted partition by the user, s corresponding to a number of trustee servers, u corresponding to a number of trustee users, and s+u corresponding to at least a number of partitions necessary for recovering a secret and
reconstruction 401 of the secret from each decrypted partition.

Steps 21 through 24 are identical to the steps 21 through 24 described for the method 200 for a trustee server or to the steps described in the method 300 and corresponding to steps 21 through 24 of the method 200 for a trustee user.

Steps 27-1 through 27-s are identical to step 27 of the method 200 pour s trustee servers. Steps 54-1 through 54-u are identical to step 54 of the method 300 for u trustee users. Steps 27-1 through 27-s and 54-1 through 54-u are performed either in parallel or sequentially.

Each partition decrypted in steps 27-1 through 27-s and 54-1 through 54-u is transmitted by each trustee by means of each secure channel established for each trustee during a step for the transmission by each trustee of the decrypted partition corresponding to said trustee. Each partition of the secret is sent to the user application by means of the established secure channel. This secure channel corresponds to the channel established between the user and each trustee in step 21 of the method 200 for each trustee server, or in steps 35 through 42 of the method 300 for each trustee user.

The step 401 for reconstructing the secret from each decrypted partition is performed by a user application once each partition necessary for recovering the secret has been decrypted and received by the user application. The partitions necessary for recovering the secret are at least each so-called “primary partition” corresponding to each mandatory trustee, the correspondence being defined during the method for backing up a secret. If, during the method for backing up the secret, at least one non-mandatory trustee has been determined, a complement of secondary partitions from among the secondary partitions corresponding to a non-mandatory trustee may be necessary to recover the secret; said complement being such that the sum of the number of partitions of mandatory trustees and of the complement of partitions of non-mandatory trustees is equal to a predetermined limit value of trustees determined during the backup of the secret, a so-called “secondary partition” being a partition corresponding to a non-mandatory trustee.

In some embodiments, a server is a mandatory trustee. In some embodiments, only a trustee user is a mandatory trustee.

In some embodiments, each step for the transmission by each trustee of the decrypted partition corresponding to said trustee is performed after each secure channel between the user and each trustee is established.

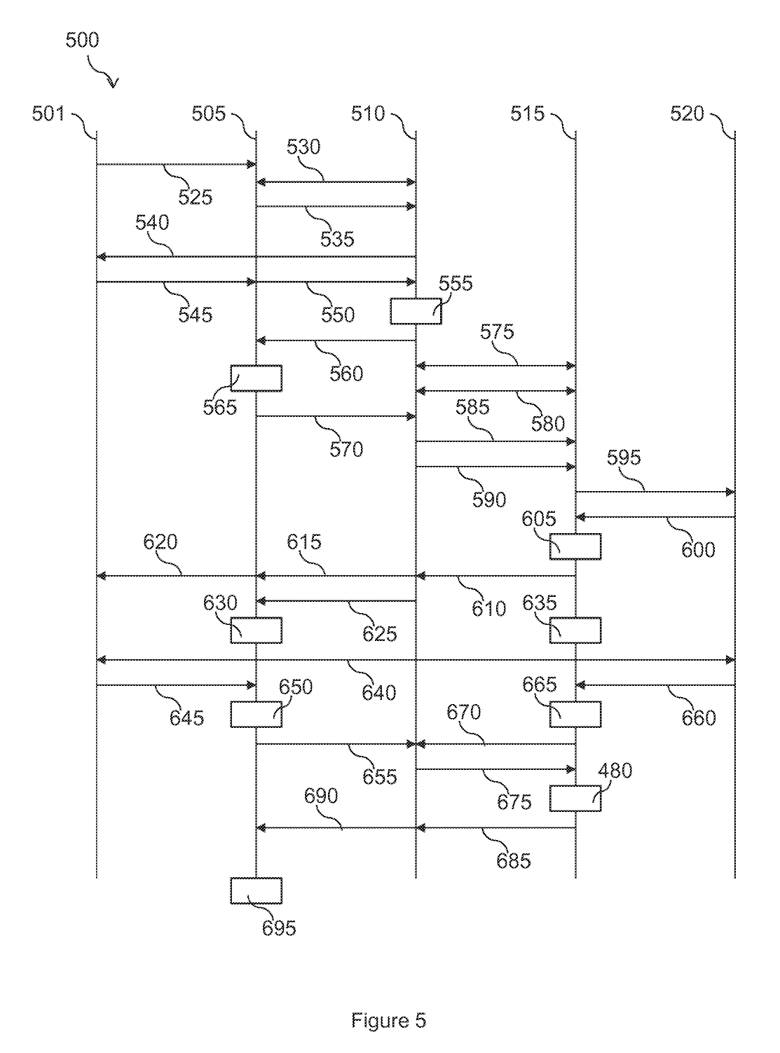

We see in FIG. 5 the steps of a particular embodiment of a method for recovering a secret 500 according to the present invention. The method 500 is an embodiment wherein the user has determined two trustees. The two trustees are mandatory trustees and no non-mandatory trustee is determined. One trustee is a user called a “trustee user,” and the second trustee is a server. The method 500 describes the steps for decrypting each partition of the secret. Moreover, the steps for recovering the partition corresponding to the trustee server and the partition corresponding to the trustee user are sequenced so as to enhance the security and the ergonomics of the recovery method.

The steps of the method 500 are performed by:
a user 501,
an application 505 of said user 501,
a server 510 in which each partition of the secret is stored,
a trustee user 520 or
an application 515 of said trustee user 520 called a “trustee application.”

Each action of the server 510 is logged for auditing purposes.

The user 501 sends the application 505 a recovery request 525. The application 505 makes a connection 530 with the server 510. The connection 530 to the server 510 is preferably a TLS connection.

After the connection 530 of the application 505 to the server 510, the application 505 sends the server 510 a request 535 for the recovery of the partition of the secret corresponding to the trustee user 520. The request 535 is logged by the server 510.

Once the request 535 has been made by the application 505, the server 510 sends 540 an authentication challenge to the user from the server. The challenge is preferably a URI. The challenge is sent to the user by email if the user has provided an email address. The challenge can be sent by SMS or MMS.

The user 501 indicates 545 the response to the challenge to the application 505, and the application 505 relays 550 this response to the server 510.

The server 510 performs a verification 555 of the challenge. The server 510 may deny the request 535 if the challenge is not verified. If the challenge is verified, the server 510 communicates 560 to the application 505 that the procedure has been accepted. The verification 555 is logged by the server 510.

The application 505 determines 565 a short code and uses it to encrypt a challenge. The short code is a password, for example. Preferably, the short code is a PIN code. Preferably, said encrypted challenge is a Diffie-Hellman exchange.

The application 505 transmits 570 to the server 510 a value X* of the result of the encryption performed by the application 505.

The trustee user 520 connects 575 to the server 510 by means of the trustee application 515. The trustee user 520 is then authenticated 580 in the server 510 by means of the trustee application 515. As long as the trustee user 520 is not authenticated in the server 510, the method 500 is placed on standby.

Next, the server 510 notifies 585 the trustee application 515 of the recovery request from the user 501. The server 510 transfers 590 the value X* of the result of the encryption to the trustee application 515.

The notification 585 of the recovery request is indicated by the trustee application 515 to the trustee user 520. The trustee user 520 can accept 600 the recovery request by means of the trustee application 515.

Once the recovery request is accepted by the trustee user 520, the trustee application 515 determines 605 a short code called a “trustee short code” and uses it to encrypt a challenge. The short code is a password, for example. Preferably, the trustee short code is a PIN code. Preferably, said encrypted challenge is a Diffie-Hellman exchange.

The application 515 transmits 610 to the server 510 a value Y* of the result of the encryption performed by the application 515.

Next, the server 510 notifies 615 the application 505 of the acceptance of the recovery request by the trustee user 520. The server 510 transfers 625 the value Y* of the result of the encryption of the challenge to the trustee application 515.

The notification 585 of the recovery request is indicated by the trustee application 515 to the trustee user 520.

Simultaneously, the application 505 displays 630 the short code and the trustee application 515 displays 635 the trustee short code.

A communication 640 between the user 501 and the trustee user 520 is established by the user 501 or the trustee user 520. The user 501 and the trustee user 520 identify themselves to each other. The user 501 and the trustee user 520 exchange the short code and the trustee short code. Preferably, the communication 640 is a telephone communication. In some embodiments, the communication 640 takes place orally, by email, by SMS or by MMS.

Once the short codes are exchanged, the user 501 enters 645 the trustee short code by means of the application 505. The application 505 calculates a mutual secret and a mutual verification key by means of the values x (a Diffie-Hellman secret being such that X=g^{x}) and Y resulting from the decryption of the challenge Y*. The mutual verification key is transmitted 655 by the application 505 to the server 510. The transmission step 655 includes a step for the confirmation to the server 510 by the user 501 of the creation of a verification key.

Once the short codes are exchanged, the user 520 enters 660 the short code by means of the application 515. The application 515 calculates a mutual secret and a mutual verification key using the values y (a Diffie-Hellman secret being such that Y=g^{y}) and X resulting from the decryption of the challenge X*. The mutual verification is transmitted 670 by the application 515 to the server 510. The transmission step 670 includes a step for the confirmation to the server 510 by the trustee user 520 of the creation of a verification key. The mutual secret and mutual verification key must be identical for both the calculation 650 performed by the application 505 and the calculation 665 performed by the application 515.

Steps 660, 665 and 670 can be performed in parallel with steps 645, 650 and 655.

After the mutual verification key is accepted and verified as being identical, the server 510 sends 675 the trustee application 515 the partition encrypted by the public key of the trustee user 520 corresponding to said trustee user 520. The application 515 decrypts 680 the partition corresponding to said trustee user 520 by means of the private key of said trustee user 520, then in the same step, the trustee application 515 re-encrypts the partition corresponding to said trustee user 520 by means of the mutual secret.

The re-encrypted partition is transferred 685 to the server 510. The server 510 decrypts the partition for which it is the trustee, and transmits 690 the decrypted partition for which said server is the trustee and the re-encrypted partition of the trustee user to the application 505.

Finally, the application 505 decrypts 695 the re-encrypted partition by means of the mutual verification key, and reconstructs the user secret by means of the two partitions received.

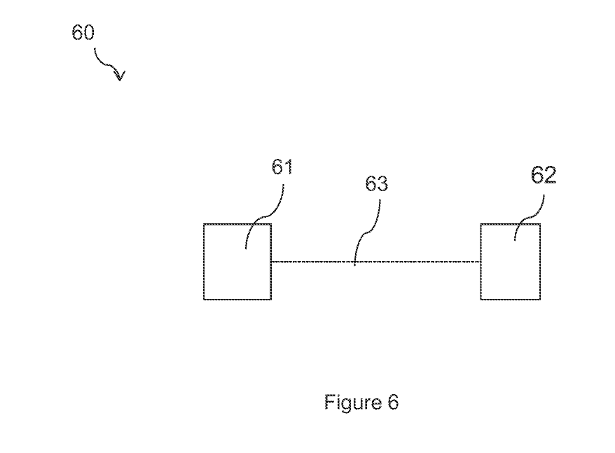

We see in FIG. 6 a device 60 for backing up a secret according to the present invention and/or for recovering a secret according to the present invention.

The device 60 comprises a program memory 61 and a central processing unit 62 which comprises at least one server and which, by executing instructions of the program, performs the steps of a backup method according to the present invention and/or a recovery method according to the present invention. The steps performed by the program are preferably steps comprised in the described particular embodiments of methods 100, 200, 300, 400 and/or 500.

The central processing unit 62 is connected to the memory 61 and accesses 63 the program stored in the memory 61. The central processing unit 62 executes, by means of the server, the instructions of the program stored in the memory 61.

Preferably, the server logs each action performed for auditing purposes.

1-11. (canceled)

12. Method for backing up a user secret, comprising the steps of:
determining a set of mandatory trustees, each mandatory trustee possessing a public key;
determining a set of non-mandatory trustees, each non-mandatory trustee possessing a public key;
selecting a predetermined limit value of a number of partitions necessary for recovering the user secret by a user, the predetermined limit value is greater than or equal to a number of mandatory trustees,
generating a number of primary partitions equal to a number of mandatory trustees, each primary partition comprising at least a part of the user secret and corresponding to a mandatory trustee in response to the determination that the set of non-mandatory trustees is empty;
generating a number of primary partitions equal to the number of mandatory trustees plus one, each primary partition comprising at least a part of the user secret and each partition except one corresponding to a mandatory trustee in response to the determination that the set of non-mandatory trustees is not empty;
generating a number of secondary partitions comprising content of a remaining primary partition divided in accordance with a secret sharing method and corresponding to a non-mandatory trustee in response to the determination that the set of non-mandatory trustee is not empty;
encrypting each primary partition and each secondary partition using a public key of a corresponding trustee; and
storing each encrypted partition in a server.

13. Method according to claim 12, wherein at least one trustee is a server.

14. Method according to claim 12, wherein at least one trustee is the user.

15. Method for recovering a user secret, comprising the steps of:
establishing a secure channel between a user and at least one predetermined limit value of trustees of a partition of the user secret, the predetermined limit value corresponding to a number of partitions of the user secret necessary for recovering the user secret, the user authenticating each trustee and each trustee authenticating the user;
requesting recovery of the user secret by the user to a server;
decrypting at least one predetermined limit value of partitions, each partition is decrypted by a private key of a corresponding trustee;
transmitting to the user by each trustee of a partition corresponding to a decrypted trustee over the secure channel; and
reconstructing the user secret from each decrypted partition.

16. Method according to claim 15, further comprising the steps of:
sending an authentication challenge to the user by the server; and
transmitting by the user to the server a response to the authentication challenge authenticating the user in the server.

17. Method according to claim 15, further comprising the step of establishing a secure channel between the user and a trustee user by:
determining a password by the user;
sending an user Diffie-Hellman exchange encrypted by the password to the trustee user via the server by the user;
determining a trustee password by the trustee user;
sending a trustee Diffie-Hellman exchange encrypted by the trustee password to the user via the server by the trustee user;
reciprocal authenticating the user and the trustee user via a third-party channel;
exchanging each password between the user and the trustee user over said third-party channel;
decrypting the trustee Diffie-Hellman exchange using the trustee password by the user; and
decrypting the user Diffie-Hellman exchange using the password by the trustee user.

18. Method according to claim 15, wherein the step of requesting the recovery of the user secret comprises the step of notifying a trustee of the recovery request.

19. Method according to claim 15, wherein at least one partition corresponds to the server and at least one partition corresponds to the user; and further comprising the step of decrypting each partition corresponding to each server after an authentication of the user by each trustee user.

20. Method according to claim 15, wherein the step of transmitting to the user by said each trustee of the partition corresponding to the decrypted trustee is performed after each secure channel between the user and said each trustee is established.

21. Device for backing up a user secret, comprising:
a program memory; and
a central processing unit comprising at least one server and configured to:
determine a set of mandatory trustees, each mandatory trustee possessing a public key;
determine a set of non-mandatory trustees, each non-mandatory trustee possessing a public key;
receive a predetermined limit value of a number of partitions necessary for recovering the user secret selected by a user, the predetermined limit value is greater than or equal to a number of mandatory trustees,
generate a number of primary partitions equal to a number of mandatory trustees, each primary partition comprising at least a part of the user secret and corresponding to a mandatory trustee in response to the determination that the set of non-mandatory trustees is empty;
generate a number of primary partitions equal to the number of mandatory trustees plus one, each primary partition comprising at least a part of the user secret and each partition except one corresponding to a mandatory trustee in response to the determination that the set of non-mandatory trustees is not empty;
generate a number of secondary partitions comprising content of a remaining primary partition divided in accordance with a secret sharing method and corresponding to a non-mandatory trustee in response to the determination that the set of non-mandatory trustee is not empty;
encrypt each primary partition and each secondary partition using a public key of a corresponding trustee; and
store each encrypted partition in said at least one server.

22. Device for recovering a user secret, comprising:
a program memory;
a central processing unit comprising at least one server and configured to:
establish a secure channel between a user and at least one predetermined limit value of trustees of a partition of the user secret, the predetermined limit value corresponding to a number of partitions of the user secret necessary for recovering the user secret, the user authenticating each trustee and each trustee authenticating the user;
receive a request for recovery of the user secret from the user for said at least one server;
decrypt at least one predetermined limit value of partitions, each partition is decrypted by a private key of a corresponding trustee;
transmit to the user from each trustee of a partition corresponding to a decrypted trustee over the secure channel; and
reconstruct the user secret from each decrypted partition.
